(19) United States
(12) Patent Application Publication
(10) Pub. No.: US 2009/0307591 A1
(43) Pub. Date: Dec. 10, 2009

(54) Virtual remote controller

(76) Inventors: Duyet D. Pham, San Diego, CA (US); Yong Zhang, Poway, CA (US)

Correspondence Address: MILLER PATENT SERVICES, 2500 DOCKERY LANE, RALEIGH, NC, 27606, US

(21) Appl. No.: 12/157,238

(22) Filed: Jun. 9, 2008

(51) Int. Cl. G06F 3/00

(52) U.S. Cl. 715/716

(57) ABSTRACT

An entertainment system often contains a number of entertainment devices, such as a television, VCR, DVD player, CD player, Cable-TV box, and other devices each of which has a remote controller associated with the device. This often results in a confusing welter of remote controllers to operate the system as a whole. A system and method for displaying control function icons on a television display is presented here. The control function icons are displayed in large font, hi-intensity icons as an overlay on a television screen. There are a number of the graphic icon sets that may be mapped, one to each device in the system that has a remote controller. The user may then select the set of icons for the device to be controlled, select the function desired, and the control function code is sent to the infrared receiver of the device to be controlled. This Virtual Remote Controller is maintained in non-volatile memory within the television and may be expanded to map each non-television device in the entire entertainment system such that all are controlled from visual icons on the television display. This abstract is not to be considered limiting, since other embodiments may deviate from the features described in this abstract.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

Practically every audio and video device used in the home for the presentation of entertainment content is equipped with a remote control device to allow the device to be controlled regardless of the location of a user of the device within an enclosed area. Remote control devices typically utilize infrared (IFR) frequency command signals transmitted from the remote controller to an IFR receiver in the device. The command signals captured by the device are used to perform functions desired by the user of the system. Frequently, a user with even a moderately complex system of devices will accumulate a number of remote controllers, each dedicated to a different device and all working within the same audio visual system grouping of equipment.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a group of control graphics consistent with certain embodiments of the present invention.

FIG. 2 is a layout of Virtual Remote Controller control graphics consistent with certain embodiments of the present invention

FIG. 3 is a presentation of the VRC control graphics on the screen of a video monitor consistent with certain embodiments of the present invention.

FIG. 4 is a flow layout for the VRC learning mode consistent with certain embodiments of the present invention.

FIG. 5 is a flow layout for the VRC operation mode consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

It has been noted that even moderately complex accumulations of audio and video entertainment devices will present a user with a number of remote control devices, each dedicated to a particular device. This can present certain frustrations when seeking the remote control from among the group that controls the device currently in use, especially if the remote control is missing or misplaced. Accumulating all of these controllers into a single source would be beneficial to a user. Certain embodiments that address these issues are presented in the following disclosure.

The use of multiple remote control devices can cause frustration and difficulty not simply because a certain device may be missing. Frequently, the location of the complete entertainment system is in a room with low light intensity so as to enhance the contrast of video content for viewing purposes. This low light intensity makes it difficult to identify the graphics emblazoned upon small keys that are inset into the remote controllers, particularly if the remote control has a small footprint, making it difficult to use the controller in the entertainment room. There is additional disadvantage to older users whose eyesight is no longer keen enough to discern the key graphics even in nominal light intensities. There are devices in the marketplace that allow a user to concentrate all of the functionality of a group of remote controllers into a single device, but this device has all of the problems associated with low light intensities and poor vision of users as well as being more complex to use. Many “universal remote control” devices have a much larger number of control function keys on the device because the device must provide all of the control functions for widely different controllers in one physical device. Thus, although a universal remote control device may assist with reducing the number of remote control devices for a medium to large entertainment system, there is a definite limit to the number of devices that may be replaced by the universal remote control device and it does not remedy the issues of using the device in low light intensity environments.

A Virtual Remote Controller as described in certain embodiments herebelow is presented to address the issues of replacing a large number of remote control devices with a single source for control signals, managing different sets of control keys with different command graphics, and overcoming the problem of low light intensity in an entertainment viewing area such as a home theater or other viewing area within an enclosed space.

An entertainment system often contains a number of entertainment devices, such as a television, VCR, DVD player, CD player, Cable-TV box, and other devices each of which has a remote controller associated with the device. This often results in a confusing welter of remote controllers to operate the system as a whole. A system and method for displaying control function icons on a television display is presented here. The control function icons are displayed in large font, hi-intensity icons as an overlay on a television screen. There are a number of the graphic icon sets that may be mapped, one to each device in the system that has a remote controller. The user may then select the set of icons for the device to be controlled, select the function desired, and the control function code is sent to the infrared receiver of the device to be controlled. This Virtual Remote Controller is maintained in non-volatile memory within the television and may be expanded to map each non-television device in the entire entertainment system such that all are controlled from visual icons on the television display.

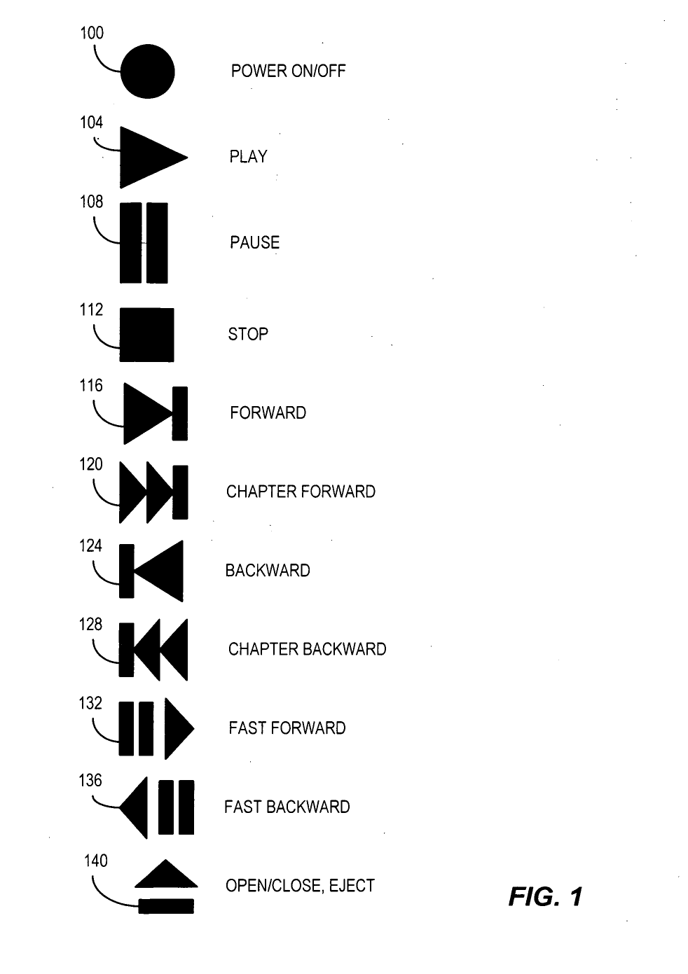

Turning now to FIG. 1, a set of graphics primitives that represent a typical set of control functions for one of a series of non-television entertainment devices is presented. In an exemplary embodiment, these graphics primitive shapes are configured to provide a given control command when selected. For example, when selected the Power On/Off 100 graphics primitive will cause emission of a control signal to turn the power on or off in a toggle fashion when selected by a user when the control graphic is visible on the television monitor. The set of primitives available, in a certain embodiment, may include Play 104, Pause 108, Stop 112, Forward 116, Chapter Forward 120, Backward 124, Chapter Backward 128, Fast Forward 132, Fast Backward 136, and Open/Close/Eject 140. Each control graphic primitive is defined within non-volatile memory in the television monitor and is displayed upon request by the user. Each device that is set up to be controlled by the Virtual Remote Controller process has a separate memory area and a separate set of control graphics that will appear when that particular device is selected from a menu on the television monitor.

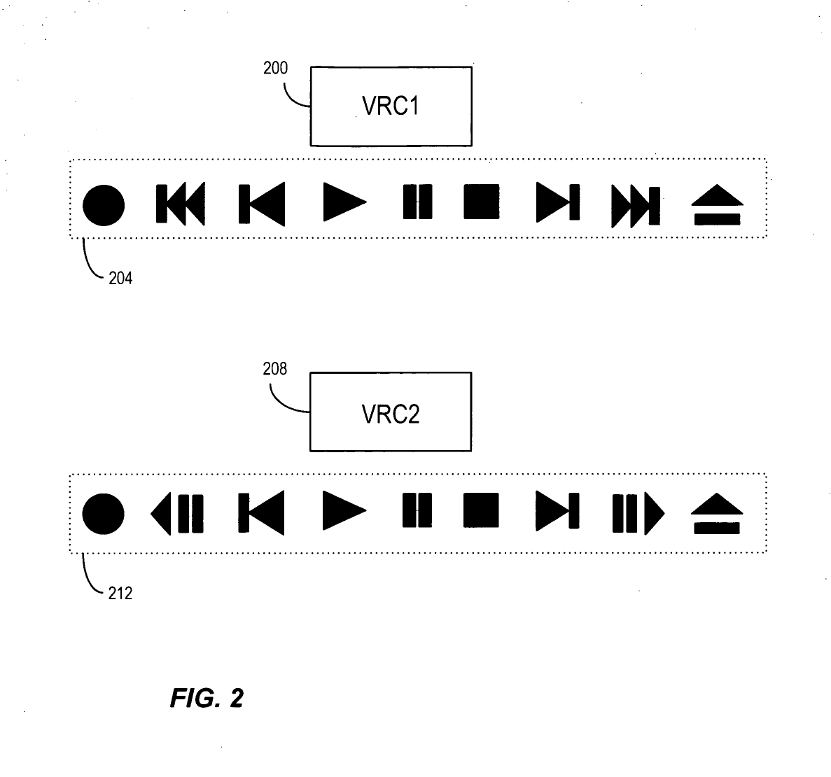

Turning now to FIG. 2, this figure presents a certain embodiment in which multiple VRC command graphics may be displayed to a user. VRC1 200 is the label for the first non-television entertainment device for which a user may define graphic keys for later use. When a user selects the VRC mode on the television remote control a series of VRC labeled graphics keys will be displayed on the television screen. The user may select any VRC label on the screen for immediate use, or may select a new VRC label for definition of a new entertainment device to be input. In this figure two representative VRC labeled graphic key sets are presented, VRC1 200 and VRC2 208. The user may select either for use with a given non-television device. For example, the user may select VRC1 200 and then select learning mode from the television remote. The VRC controller module within the television enters learning mode and activates the graphic key set 204 for learning. The user then directs the remote controller for the particular entertainment device that the user would like to control using the graphics key set 204 and points it at the television. The user then depresses each of the like labeled keys on the entertainment device remote control while pointing it at the television. The VRC software module captures the IFR code for each control key in turn and attaches that code to the graphics control key in non-volatile memory reserved for VRC 1 200.

Once all control keys have been captured by the television, the user may be directed to modify the label for VRC1 200 from a pop-up screen of device names. The user may select the device name that is capable of being controlled from the VRC1 200 graphics key set on the television and the label is changed to that device name. In this manner, the user will be able to define which device is controlled by which VRC graphic key set at a glance and be able to page through them to select the desired device.

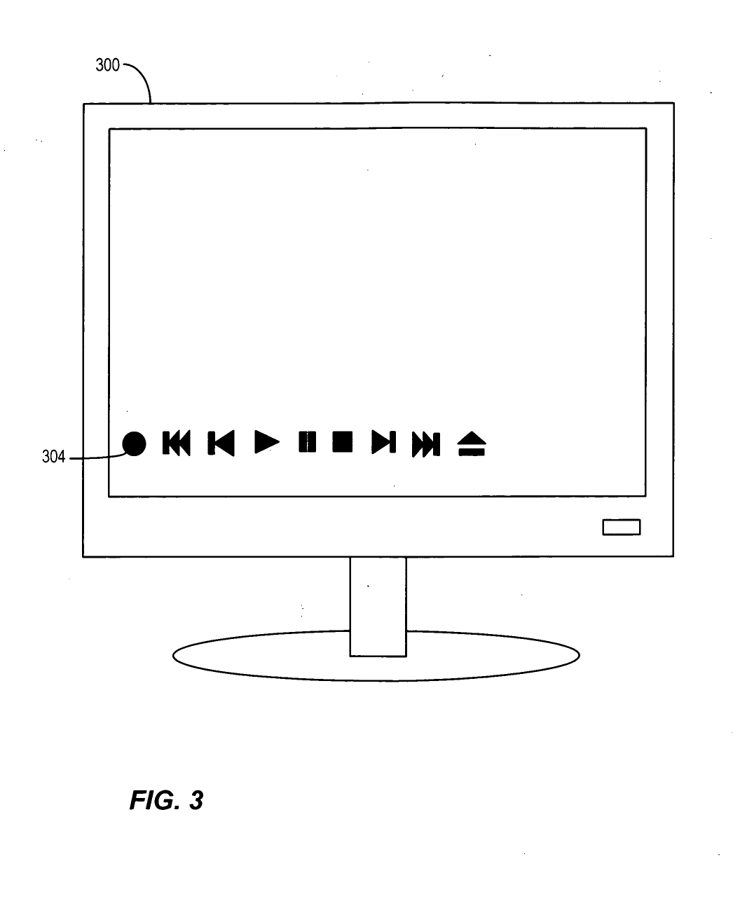

Turning now to FIG. 3, this figure presents an exemplary view of the graphics control keys that will appear on a television screen when the user has selected a non-television device for control using the Virtual Remote Controller operation function. As shown in this figure, the graphics key set is large and in a high contrast color, allowing older users to see them easily and allowing all users to see them readily against any scene that may be currently displayed on the television screen. In addition, the high contrast color of the graphics control keys on the screen makes them easily visible in low light intensity viewing rooms.

In certain embodiments consistent with the invention, the selection by a user of the VRC operation function results in the display presenting the graphic key set for a particular non-television device as selected by the user. This graphic key set may, in certain embodiments, consist of only the most frequently used keys, maximizing the utility for the user and minimizing the number of functions a user needs to sort through to operate the non-television entertainment device effectively. This operational pattern remains consistent throughout the specification and use of the VRC graphic key sets.

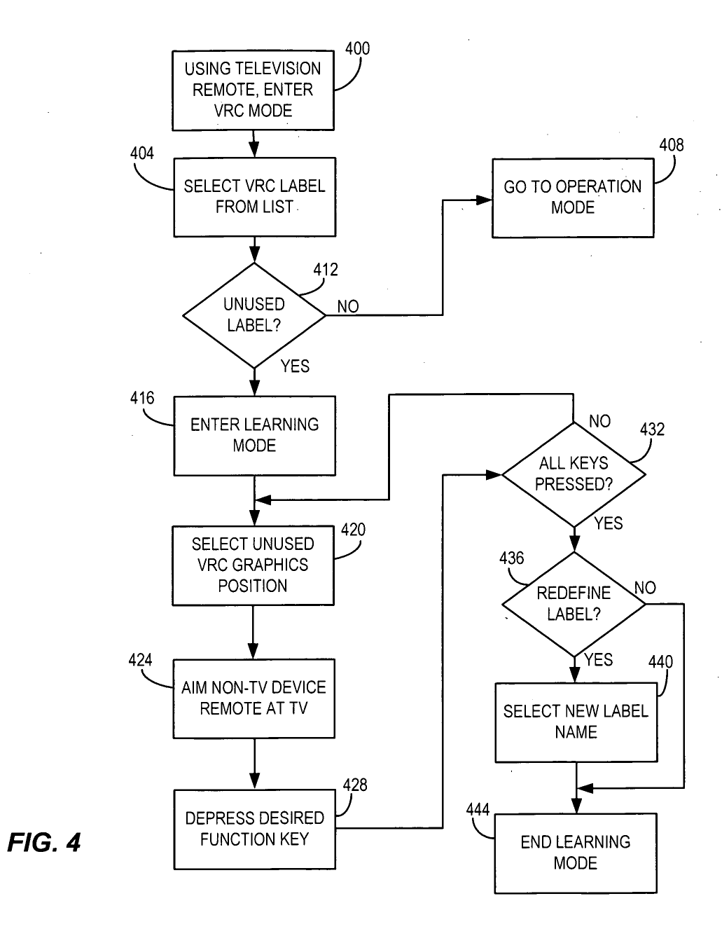

Turning now to FIG. 4, this figure presents an exemplary embodiment of the VRC learning mode. To initiate this mode a user will utilize the television remote controller that has the Virtual Remote Controller function built into the physical remote 400. Once the user selects the VRC function the VRC software module displays a series of graphical function key sets, each with their own label (see FIG. 2), on the television screen. The user may press the down triangle “▾” to highlight the next VRC label in succession. The user may also press the up triangle “▴” key if the desired graphics key set has been passed and the user needs to move back up through the set of labels to select the desired VRC label 404. If an unused VRC key set label is selected the VRC software module will enter the learning mode 420.

In an exemplary embodiment, entry into the learning mode 416 provides the user with the ability to map a graphics key within the VRC graphics key set to a physical function key on a non-television remote control device. This function mapping is then retained within the television in non-volatile memory allocated to the selected VRC graphics key set such that a user no longer needs to use the non-television device physical remote controller to access the functions that have been learned by the VRC graphics key set.

Once in learning mode, the user points the television remote control at the television and uses the right triangle key [symbol] and the left triangle key [symbol] to highlight the graphics key within the selected graphics key set the user would like to map to a function code of the non-television device remote control 424. The user then points the non-television device physical remote control at the television set and depresses the function key to be learned 428. The control code is emitted by the physical device remote controller and captured by the VRC software module within the television set. This code is now mapped to the VRC graphics function key displayed upon the television screen under the selected VRC label. The user may repeat this process 432 for all functions of the non-television device that the user would like to control from the VRC label displayed on the television.

Once all desired functions of the non-television entertainment device have been mapped to graphics keys within the selected VRC label the user may change the label of the VRC label displayed on the television 436. The user is presented with a list of terms from which a new label name may be selected 440. The list of terms will, in an exemplary embodiment, contain many of the names of current non-television entertainment devices such as, by way of example, DVD, VCR, RECEIVER, CABLE BOX, AMPLIFIER, and other, less-common entertainment devices. The user may once again utilize the down triangle “▾” and up triangle “▴” functions on the television physical remote control to move through the list of label names. The user may select the desired label name by pressing the “Enter” key while the label name is highlighted. This action replaces the generic label with the selected label name for the device the VRC software module has just learned.

The user may exit the VRC by pressing either the “return” function key or the “Menu” function key on the television remote controller 444. This will end the learning mode at the point the user pressed that particular key, saving any changes to non-volatile memory automatically upon exit.

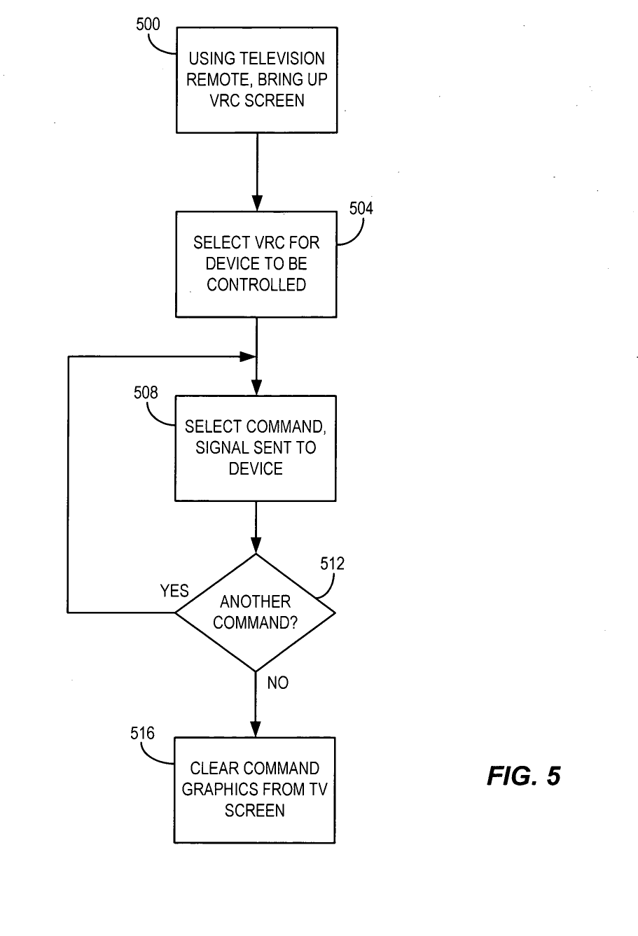

Regarding FIG. 5, this figure represents an exemplary embodiment for the operation of the VRC after one or more VRC graphic key sets have been learned by the television. The user simply uses the television remote control to recall the VRC list of defined and labeled graphic key sets 500. The user may press the down triangle “▾” to highlight the next VRC label in succession. The user may also press the up triangle “▴” key if the desired graphics key set has been passed and the user needs to move back up through the set of labels to select the desired VRC label 504. Once the desired VRC labeled graphics key set for a desired non-television device has been highlighted, the user may use the left triangle [symbol] and right triangle [symbol] keys to navigate the list of graphic function keys until the desired function is highlighted 508. The user then simply presses the enter key to operate the function, sending the proper IFR code for that control to the selected device and causing the selected device to perform the desired action. The user may repeat these steps if more than one command function is desired to be implemented 512.

In an exemplary embodiment, the television may employ an optical fiber to convey the selected IFR code to the infrared sensor of the selected device. In another exemplary embodiment, the television may emit a narrow IFR beam to an external reflector located in front of the television. This reflector, in the shape of a small hemisphere reflects the IFR signal to all devices within the entertainment center and causes the selected device to receive the command code and perform the desired function.

The user may exit the VRC by pressing either the “return” function key or the “Menu” function key on the television remote controller 516. This will end the operational command mode at the point the user pressed that particular key, clearing the command graphics key set from the television display 516.

Thus, this document describes a method for controlling non-television entertainment devices from a television by defining at least one set of graphic icons within a television memory, grouping each set of graphic icons under a label such that the icons are displayed together and stored in the television memory. Each set of graphic icons is mapped to function codes representing particular non-television device functions as they are transmitted from a non-television remote control device and links each of said non-television device functions to a selected graphic icon. The system displays on the television display a selected group of graphic icons at a request from a user and transmits a non-television device function code through an infrared transmission device associated with said television when one of said graphic icons is selected on the television screen. The transmission of the non-television function code is operative to cause the non-television entertainment device to perform the selected function.

In certain embodiments, the graphic icons displayed upon user request are displayed in a high-intensity, hi-contrast color and the grouping of icons under a single label associates that grouping of icons with a single non-television device. The television memory is non-volatile memory and is a contiguous area of memory for each set of graphics icons.

In certain embodiments, the linking can be performed by capturing a transmitted infrared function code, associating the captured code with the selected graphics icon, and storing the updated association in television memory. A previously defined set of graphics icons may be selected and linked to a set of non-television function codes different from the previous definition. The graphics label identifier for a set of graphics icons may be modified to reflect the name of the non-television entertainment device to which the set of graphics icons are mapped.

In certain embodiments, a system for controlling non-television entertainment devices from a television is described that contains a processor within a television operative to display graphics icon sets as an overlay on a television display, an area of memory in which display graphics icon sets are stored within the television device and at least one set of graphics icons representing control functions for non-television entertainment devices and a label for each device. A capture function is available to capture non-television entertainment device IFR control codes for storage within said memory and a linking function is available to link a selected graphics display icon to a captured non-television entertainment device IFR control code within said memory. A selection function is used to permit a user to select at least one set of displayed graphics icons and further select one of the graphics icons, and an IFR transmission device is used to transmit the non-television entertainment device IFR control code associated with the user selected graphics icon. The system is configured such that the transmitted IFR control code is operative to cause the non-television entertainment device to perform the selected function.

In certain embodiments, the graphics display icons are displayed in a high-intensity, hi-contrast color on the television display. The predefined area of memory is non-volatile memory and is a contiguous area of memory for each set of graphics display icons. A previously defined set of graphics display icons may be remapped to a set of non-television function codes different from the previous definition, and the graphics label identifier for a set of graphics icons is selected from a pre-defined menu of non-television device names.

The above overviews are intended to illustrate exemplary embodiments which will be best understood in conjunction with the detailed description to follow, and are not intended to limit the scope or meaning of the appended claims.

While certain illustrative embodiments have been described, it is evident that many alternatives, modifications, permutations and variations will become apparent to those skilled in the art in light of the foregoing description.

What is claimed is:

1. A method for controlling non-television entertainment devices from a television, comprising:
defining at least one set of graphic icons within a television memory;
grouping each set of graphic icons under a label such that the icons are displayed together and stored in said television memory;
mapping each set of graphic icons to function codes representing particular non-television device functions as they are transmitted from a non-television remote control device;
linking each of said non-television device functions to a selected graphic icon;
displaying on the television display a selected group of graphic icons at a request from a user;
transmitting a non-television device function code through an infrared transmission device associated with said television when one of said graphic icons is selected on the television screen; and
wherein the transmission of said non-television function code is operative to cause the non-television entertainment device to perform the selected function.

2. A method as in claim 1, wherein the graphic icons displayed upon user request are displayed in a high-intensity, high-contrast color.

3. A method as in claim 1, wherein the grouping of icons under a single label associates that grouping of icons with a single non-television device.

4. A method as in claim 1, wherein said television memory is non-volatile memory.

5. A method as in claim 4, wherein said television memory is a contiguous area of memory for each set of graphics icons.

6. A method as in claim 1, wherein said linking is performed by capturing a transmitted infrared function code, associating the captured code with the selected graphics icon, and storing the updated association in television memory.

7. A method as in claim 1, wherein a previously defined set of graphics icons may be selected and linked to a set of non-television function codes different from the previous definition.

8. A method as in claim 1, wherein the graphics label identifier for a set of graphics icons may be modified to reflect the name of the non-television entertainment device to which the set of graphics icons are mapped.

9. A system for controlling non-television entertainment devices from a television, comprising:
a processor within a television operative to display graphics icon sets as an overlay on a television display;
an area of memory in which display graphics icon sets are stored within the television device;
at least one set of graphics icons representing control functions for non-television entertainment devices and a label therefore;
a capture function to capture non-television entertainment device IFR control codes for storage within said memory;
a linking function to link a selected graphics display icon to a captured non-television entertainment device IFR control code within said memory;
a selection function to permit a user to select at least one set of displayed graphics icons and further select one of the graphics icons;
an IFR transmission device to transmit the non-television entertainment device IFR control code associated with the user selected graphics icon; and
wherein the transmitted IFR control code is operative to cause the non-television entertainment device to perform the selected function.

10. A system as in claim 9, wherein the graphics display icons are displayed in a high-intensity, high-contrast color on the television display.

11. A system as in claim 9, wherein said area of memory is non-volatile memory.

12. A system as in claim 10, wherein said area of memory is a contiguous area of memory for each set of graphics display icons.

13. A system as in claim 9, wherein a previously defined set of graphics display icons may be remapped to a set of non-television function codes different from the previous definition.

14. A method as in claim 9, wherein the graphics label identifier for a set of graphics icons is selected from a pre-defined menu of non-television device names.

15. A computer readable storage medium storing instructions for controlling non-television entertainment devices from a television processor, comprising:
defining at least one set of graphic icons within a television memory;
grouping each set of graphic icons under a label such that the icons are displayed together and stored in said television memory;
mapping each set of graphic icons to function codes representing particular non-television device functions as they are transmitted from a non-television remote control device;
linking each of said non-television device functions to a selected graphic icon;
displaying on the television display a selected group of graphic icons at a request from a user;
transmitting a non-television device function code through an infrared transmission device associated with said television when one of said graphic icons is selected on the television screen; and
wherein the transmission of said non-television function code is operative to cause the non-television entertainment device to perform the selected function.

16. A computer readable medium as in claim 15, wherein the graphic icons displayed upon user request are displayed in a high-intensity, hi-contrast color.

17. A computer readable medium as in claim 15, wherein the grouping of icons under a single label associates that grouping of icons with a single non-television device.

18. A computer readable medium as in claim 15, wherein said television memory is non-volatile memory.

19. A computer readable medium as in claim 18, wherein said television memory is a contiguous area of memory for each set of graphics icons.

20. A computer readable medium as in claim 15, wherein said linking is performed by capturing a transmitted infrared function code, associating the captured code with the selected graphics icon, and storing the updated association in television memory.

21. A computer readable medium as in claim 15, wherein a previously defined set of graphics icons may be selected and linked to a set of non-television function codes different from the previous definition.

22. A computer readable medium as in claim 15, wherein the graphics label identifier for a set of graphics icons may be modified to reflect the name of the non-television entertainment device to which the set of graphics icons are mapped.
